(19) United States
(12) Patent Application Publication
(10) Pub. No.: US 2010/0215799 A1
(43) Pub. Date: Aug. 26, 2010

(54) CHEWING GUM COMPOSITION

(75) Inventors: Terence Cosgrove, Portishead (GB); Erol A. Hasan, Liverpool (GB); Voss M. Gibson, Sydney (AU)

Correspondence Address: OLIFF & BERRIDGE, PLC, P.O. BOX 320850, ALEXANDRIA, VA, 22320-4850, US

(73) Assignee: REVOLYMER LIMITED, LONDON (GB)

(21) Appl. No.: 12/449,622

(22) PCT Filed: Feb. 26, 2008
(86) PCT No.: PCT/EP2008/052325

§ 371 Date: Apr. 19, 2010

(30) Foreign Application Priority Data
Feb. 26, 2007 (EP) 07103052.2
Nov. 26, 2007 (EP) 07121564.4

(51) Int. Cl. A23G 4/08; A23G 4/00

(52) U.S. Cl. 426/6; 426/3

(57) ABSTRACT

Chewing gum base including i. 1 to 99% by weight of a polymeric material which has a straight or branched chain carbon-carbon backbone and a multiplicity of side chains, and is substantially insoluble in water; ii. from 0-6% by weight wax; iii. up to 99% by weight of an elastomeric material different to the polymeric material; and iv. 0 to 20% by weight of an elastomer plasticiser; in which the total amount of polymeric material and elastomeric material is at least 10% by weight of the chewing gum base. A chewing gum composition including this chewing gum base, and methods of manufacture, are also provided.

The present invention relates to new chewing gum bases and compositions with reduced adhesion to surfaces.

After chewing a typical chewing gum formulation, a water insoluble portion, commonly known as the ‘cud’ remains. The major component of the cud is the original chewing gum base. Although the cud can in principle be easily disposed of, when disposed of irresponsibly it leads to a number of environmental problems, most notably the cost required to remove cuds from public places.

Due to their very nature, chewing gum formulations have an adhesive-like quality. Chewing gum compositions typically comprise a water-soluble bulk portion, a water insoluble chewable gum base and flavouring agents. The gum base typically contains a mixture of elastomers, vinyl polymers, elastomer solvents or plasticisers, emulsifiers, fillers and softeners (plasticisers). The elastomers, waxes, elastomer solvents and vinyl polymers are all known to contribute to the gum base's adhesiveness.

Various approaches have been proposed to prepare “non-stick” chewing gum, i.e. chewing gum with reduced adhesiveness. One of these is to reduce or remove ingredients that increase the adhesiveness of the gum base. U.S. Pat. No. 3,984,574 describes a non-tacky chewing gum which does not adhere to dentures, fillings or natural teeth. Certain conventional chewing gum components, such as glycerol ester gums, waxes, and natural gums are excluded from the gum. In addition, the formulations may include polyvinyl acetate (PVAc), fatty acids and mono and diglyceride esters of fatty acids.

There is an increasing perception that it may not be desirable to use wax in gum bases. U.S. Pat. No. 5,336,509 describes a chewing gum base that is wax-free, or at least substantially wax-free.

U.S. Pat. No. 6,986,907 provides an easily removable gum and which is essentially free of non-silica filler, and comprises high molecular weight polyisobutylene and optionally amorphous silica and low molecular weight PVAc. The silica has an average particle size of 4.5 to 18 μm.

An alternative approach has focussed on the use of additives to reduce adhesiveness. U.S. Pat. No. 4,241,091 uses a ‘slip-agent’, which may comprise α-cellulose, texturised vegetable proteins, cellulose or protein, for this purpose. GB1025958 discloses the use of pure tannic acid to produce chewing gum which will not adhere to acrylic surfaces in the mouth.

WO99/31994 discloses a gum base including a siloxane polymer, a polar polymer and optionally a filler, which is designed to have reduced adhesion to environmental surfaces.

It has been disclosed in WO2006/016179, that certain polymeric materials have reduced tack and may reduce the adhesiveness of chewing gum compositions. The polymeric materials have a straight or branched chain carbon-carbon polymer backbone and a multiplicity of side chains attached to the backbone. The side chains are derived from an alkylsilyl polyoxyalkylene or a polyoxyalkylene. WO2006/016179, however, does not suggest that the other ingredients of the chewing gum formulation should be adapted.

There remains an unmet need to provide chewing gum bases and compositions with reduced adhesion to all surfaces, particularly those in the environment, such as pavements. These chewing gum bases and compositions should retain their chewability characteristics whilst being simple and cheap to manufacture.

In accordance with this un-met need, the first aspect of the present invention provides a chewing gum base comprising

i. 1 to 99% by weight of the chewing gum base of a polymeric material which has a straight or branched chain carbon-carbon backbone and a multiplicity of side chains, and is substantially insoluble in water;

ii. from 0-6% by weight wax;

iii. up to 99% of an elastomeric material different to the said polymeric material; and

iv. 0 to 20% by weight of an elastomer plasticiser;

wherein the total amount of polymeric material and elastomeric material is at least 10% by weight of the chewing gum base.

The incorporation of polymeric material into the gum base in the place of part of all the wax, elastomeric material and/or plasticiser reduces the adhesion and allows greater ease of removal of the cud from surfaces. The gum bases can therefore advantageously be removed by washing in water or in a mild detergent solution. Furthermore, in contrast to the gum bases of the prior art, the hardness of the gum base is altered by the solvation (plasticisation) of the polymeric material rather than solely by an increase in mouth temperature. The components of the gum base may be varied in accordance with this invention to give a variety of gum bases and compositions to suit the wide range of surfaces and environmental conditions in nature.

Of course all the compounds for the gum base must be acceptable for human consumption, e.g. be food or pharmaceutical grade.

Unless otherwise specified, % by weight values are with respect to the chewing gum base.

Typically, the polymeric material comprises 2-90% by weight of the chewing gum base, preferably, 2-50%, more preferably 2-25%, most preferably 3-20% by weight. The polymeric material may act as a substitute for part or all of the ingredients in the gum base which contribute to adhesiveness.

Examples of waxes which may be present in the gum base include microcrystalline wax, natural wax, petroleum wax, paraffin wax and mixtures thereof. Waxes normally aid in the solidification of gum bases and improving the shelf-life and texture. Waxes have also been found to soften the base mixture, improve elasticity during chewing and affect flavour retention. Preferably, the gum base comprises substantially no wax, and these properties are provided by the polymeric material.

The elastomeric material provides desirable elasticity and textural properties as well as bulk. Suitable elastomeric materials include synthetic and natural rubber. More specifically, the elastomeric material is selected from butadiene-styrene copolymers, polyisobutylene and isobutylene-isoprene copolymers. It has been found that if the total amount of elastomeric material is too low, the gum base lacks elasticity, chewing texture and cohesiveness, whereas if the content is too high, the gum base is hard and rubbery. Typical gum bases contain 10-70% by weight elastomeric material, more typically 10-15% by weight. Typically, the polymeric material will form at least 1% by weight, preferably at least 10% by weight, more preferably at least 50% by weight of the elastomeric material in the chewing gum base. In some embodiments, the polymeric material completely replaces the elastomeric material in the chewing gum base.

Elastomer plasticisers (also known as elastomer solvents) aid in softening the elastomeric material and include methyl glycerol or pentaerythritol esters of rosins or modified rosins, such as hydrogenated, dimerized, or polymerized rosins or mixtures thereof. Examples of elastomer plasticisers suitable for use in the chewing gum base of the present invention include the pentaerythritol ester of partially hydrogenated wood rosin, pentaerythritol ester of wood rosin, glycerol ester of partially dimerized rosin, glycerol ester of polymerised rosin, glycerol ester of tall oil rosin, glycerol ester of wood rosin and partially hydrogenated wood rosin and partially hydrogenated methyl ester of rosin; terpene resins including polyterpene such as d-limonene polymer and polymers of α-pinene or β-pinene and mixtures thereof. Elastomer plasticisers may be used up to 30% by weight of the gum base. The preferred range of elastomer solvent, however, is 2 to 18% by weight. Preferably it is less than 15% by weight. Alternatively, no elastomer solvent may be used.

The weight ratio of elastomer plus polymeric material to elastomer plasticiser is preferably in the range (1 to 50):1 preferably (2 to 10):1.

The chewing gum base preferably comprises a non-toxic vinyl polymer. Such polymers may have some affinity for water and include poly(vinyl acetate), ethylene/vinyl acetate and vinyl laurate/vinyl acetate copolymers. Preferably, the non-toxic vinyl polymer is poly(vinyl acetate). Preferably, the non-toxic vinyl polymer is present at 15-45% by weight of the chewing gum base. The non-toxic vinyl polymer should have a molecular weight of at least 2000. Unless otherwise specified, the unit of molecular weight used in the specification is g/mol.

In alternative embodiments, the chewing gum base comprises no vinyl polymer.

The chewing gum base preferably also comprises a filler, preferably a particulate filler. Fillers are used to modify the texture of the gum base and aid in its processing. Examples of typical fillers include calcium carbonate, talc, amorphous silica and tricalcium phosphate. Preferably, the filler is silica. The size of the filler particle has an effect on cohesiveness, density and processing characteristics of the gum base on compounding. Smaller filler particles have been shown to reduce the adhesiveness of the gum base.

Preferably, the chewing gum base comprises a softener. Softeners are used to regulate cohesiveness, to modify the texture and to introduce sharp melting transitions during chewing of a product. Softeners ensure thorough blending of the gum base. Typical examples of softeners are hydrogenated vegetable oils, lanolin, stearic acid, sodium stearate, potassium stearate and glycerine. Softeners are typically used in amounts of about 15% to about 40% by weight of the chewing gum base, and preferably in amounts of from about 20% to about 35% of the chewing gum base.

A preferred chewing gum base comprises an emulsifier. Emulsifiers aid in dispersing the immiscible components of the chewing gum composition into a single stable system. Suitable examples are lecithin, glycerol, glycerol monooleate, lactylic esters of fatty acids, lactylated fatty acid esters of glycerol and propylene glycol, mono-, di-, and tri-stearyl acetates, monoglyceride citrate, stearic acid, stearyl monoglyceridyl citrate, stearyl-2-lactylic acid, triacyetyl glycerin, triethyl citrate and polyethylene glycol. The emulsifier typically comprises from about 0% to about 15%, and preferably about 4% to about 6% of the chewing gum base.

The backbone of the polymeric material used in the chewing gum base according to the present invention is preferably derived from a homopolymer of an ethylenically unsaturated hydrocarbon monomer or from a copolymer of two or more ethylenically unsaturated hydrocarbon monomers. The base polymers from which the polymeric material is derived, i.e. without the side chains, is an elastomeric material. The polymeric material as a whole may also be an elastomeric material.

The polymeric material of the invention has a carbon-carbon polymer backbone typically derived from a homopolymer of an ethylenically-unsaturated polymerisable hydrocarbon monomer or from a copolymer of two or more ethylenically-unsaturated polymerisable hydrocarbon monomers. By the term “ethylenically-unsaturated polymerisable hydrocarbon monomer” we mean a polymerisable hydrocarbon containing at least one carbon-carbon double bond which is capable of undergoing addition or chain-reaction polymerisation to form a straight or branched chain hydrocarbon polymer having a carbon-carbon polymer backbone. According to one preferred embodiment, the carbon-carbon polymer backbone is derived from a homopolymer of an ethylenically-unsaturated polymerisable hydrocarbon monomer containing 4 or 5 carbon atoms, for example, isobutylene (2-methylpropene). The carbon-carbon polymer backbone may also, according to another embodiment, be derived from a homopolymer of a conjugated diene hydrocarbon monomer, especially one containing 4 or 5 carbon atoms, such as 1,3-butadiene or isoprene.

As mentioned above, the carbon-carbon polymer backbone may be derived from a copolymer of two or more ethylenically-unsaturated polymerisable hydrocarbon monomers. Preferably, it is derived from a copolymer of two such monomers. For example, it may be derived from a hydrocarbon copolymer of a hydrocarbon monomer having one carbon-carbon double bond and a hydrocarbon monomer having two carbon-carbon double bonds. For example, the carbon-carbon polymer backbone may be derived from a copolymer of isobutylene and isoprene. According to a different embodiment, the carbon-carbon polymer backbone is derived from a butadiene-styrene block copolymer. The backbone may be random, alternating or block, e.g. A-B or AB-A block, copolymers.

Alternatively, the backbone may be a copolymer of at least one ethylenically-unsaturated monomer and maleic anhydride. The term copolymer covers both bipolymers and terpolymers. Preferably the monomer is a hydrocarbon monomer. By the term “ethylenically-unsaturated polymerisable hydrocarbon monomer” we mean a polymerisable hydrocarbon containing at least one carbon-carbon double bond which is capable of undergoing polymerisation to form a straight or branched chain hydrocarbon polymer having a carbon-carbon polymer backbone. According to one preferred embodiment, the ethylenically-unsaturated polymerisable hydrocarbon monomer contains 4 or 5 carbon atoms, and is, for instance, isobutylene (2-methylpropene). The ethylenically unsaturated monomer may alternatively be a conjugated diene hydrocarbon monomer, especially one containing 4 or 5 carbon atoms, such as 1,3-butadiene or isoprene. The backbone may be a terpolymer, as described in the third aspect of this invention. The ethylenically-unsaturated monomer may alternatively be 1-octadecene.

In this aspect of the invention, the ethylenically unsaturated monomer may be aromatic and/or contains atoms other than hydrogen and carbon. Suitable ethylenically unsaturated monomers include styrene and vinyl methyl ether.

The hydrocarbon polymer, from which the backbone of the polymeric material is derived, typically has a molecular weight in the range 10,000 to 200,000, preferably 15,000 to 50,000, more preferably from 25,000 to 40,000.

The backbone of the polymeric material is typically hydrophobic in nature. In contrast, the side chains may be hydrophillic, which confer several advantages. The hydrophobic/hydrophilic balance of the comb-like copolymer structure leads to a substantial change in the hardness of the gum base in the dry state, making the discarded cud easier to remove from surfaces. Furthermore, hydrophillic side chains may allow saliva to act as an elastomer solvent on chewing, making the gum more chewable. This advantageously allows some or all of the wax and/or elastomer solvent content to be replaced by the polymeric material.

The hydrophillic side chains confer surface active properties on the polymeric material. In the gum base the polymeric material with hydrophillic side chains becomes surface enriched during chewing, giving a hydrophillic coating which does not bind to hydrophobic surfaces, such as asphalts and greasy paving stones. In the presence of water the polymeric material is more easily removable from the most common surfaces.

The hydrophillic side chains of the polymeric material are preferably derived from poly(ethylene oxide), poly(propylene oxide), polyglycidol, poly(vinyl alcohol), poly(styrene sulphonate) or poly(acrylic acid), most preferably poly(ethylene oxide). Poly(ethylene oxide) binds strongly to simple anionic surfactants such as those used in hair shampoo and washing up liquids, to make an electrolyte. In the presence of such anionic surfactants and water, the polymeric material is repelled by most common anionic surfaces which include many oxide surfaces, cotton clothing and hair. This advantageously allows the novel gum base to be removed by washing with soapy water.

Alternatively, the side chains may be derived from a polypeptide, for example polylysine.

Alternatively, the side chains of the polymeric material may be more hydrophobic than the backbone. Suitable examples include fluoroalkanes, polysilanes, polyalkylsilanes, alkylsilyl polyoxyalkylenes and siloxanes, which impart a very low surface energy to the gum base.

Each backbone of polymeric material may have a plurality of side chains which have different chain lengths/molecular weights. Preferably, however, each side chain has the same chain length/molecular weight.

The chewing gum base according to the present invention may comprise two or more of the polymeric materials discussed above.

Preferably, the side chains of the polymeric material have the formula

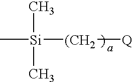

or have the formula

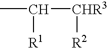

wherein R¹ is H, —C(O)OR⁴ or —C(O)Q and R² is —C(O)OR⁴ or —C(O)Q provided that at least one of R¹ and R² is the group —C(O)Q;
R³ is H or —CH₃;
R⁴ is H or an alkyl group having from 1 to 6 carbon atoms;
Q is a group having the formula —O—(YO)_{b}—(ZO)_{c}—R⁵, wherein each of Y and Z is, independently, an alkylene group having from 2 to 4 carbon atoms and R⁵ is H or an alkyl group having from 1 to 4 carbon atoms;
a is 3 or 4, and each of b and c is, independently, 0 or an integer of from 1 to 125 provided that the sum b+c has a value in the range of from 10 to 250, preferably from 10 to 120.

According to one embodiment of the present invention, the side chains in the polymeric material have the formula

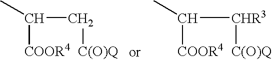

wherein R³, R⁴ and Q are as defined above. These groups are derived from maleic anhydride units or derivatives thereof grafted onto the backbone.

According to another embodiment, the side chains may have formula

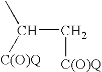

wherein Q is as defined above.

In another embodiment the side chains have the following formula

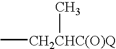

wherein Q is as defined above. These are derived from methacrylic-grafted materials.

According to another embodiment the side chains may have the formula

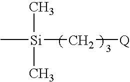

Alternatively, the side chains may have formula

—CH₂CH₂C(O)Q

These are derived from acrylic grafted materials.

Two polymeric materials which may be used in the novel chewing gum base are detailed in Table 1 below. Two partially preferred polymeric materials are P1 and P2.

TABLE 1

| Name | Backbone Starting Material | Side Chains |
|---|---|---|
| P1 | PIP-g-MA | PEO 2K |
| P2 | PIP-g-MaMme | PEO 2K |

Polymeric materials - PIP = polyisoprene;
g = graft;
MA = maleic anhydride;
MaMme = Monoacid monomethyl ester;
PEO = polyethylene oxide and
K = 1000 molecular weight units.

Any PIP-g-MA of appropriate molecular weight distribution and maleic anhydride content will be suitable for the synthesis of the graft copolymer. Alternatively carboxylated PIP-g-MA materials in which the maleic anhydride is ring opened to form a diacid or mono-acid/mono-methyl ester will also be suitable, the latter is demonstrated in P2.

The backbones of each of these polymers are derived from polyisoprene to which maleic anhydride has been grafted. The level of grafting of MA is typically around 1.0 mol % in the PIP-BMA used to demonstrate the concept. In PIP-g-MaMme the same level was 2.7 mol % of the mono-acid mono-methyl ester of MA. The level of grafting depends on the degree of functionalisation of the polyisoprene. For example, in P1 the number of grafts per chain is generally between 1 and 7, whereas in P2 it is between 1 and 10.

It is possible, by varying the alkyleneoxy side chain length, to produce a polymeric material having the desired balance of elastomeric and hydrophillic properties. Increasing the alkylenoxy chain length increases the hydrophillic nature of the polymeric material. The multipliers b and c in the group Q above are each independently from 0 to 125 provided that the sum b+c lies within the range of from 10 to 250. Preferably b+c is in the range of from 10 to 120, more preferably 20 to 60, especially from 30 to 50 and most especially from 40 to 45. This imparts to the polymer the requisite degree of hydrophilicity.

It is not necessary for all of the side chains to share the same value of b and c.

Since the hydrophobicity in the side chains increases with carbon content, it is preferred that both Y and Z are ethylene groups. Similarly, in order to not detract from the hydrophillic nature of the side chains, R⁵ is preferably H or CH₃.

As stated above, the properties of the polymeric material depend not only on the character of the side chains grafted onto the carbon-carbon polymer backbone but also on the number of grafted side chains. It is essential according to the invention that a multiplicity of side chains are attached to the backbone. The term “multiplicity” is defined herein as meaning one or more grafted side chains. The number of side chains grafted onto the carbon-carbon polymer backbone, according to the present invention, will typically be an average of at least one side chain on the carbon-carbon polymer backbone. The actual number of side chains grafted onto the carbon-carbon polymer backbone depends on the identity of the side chain and the method by which the side chain is grafted onto the polymer backbone (and the reaction conditions employed therein). In order to achieve a desired degree of hydrophillicity in the polymeric material, it is preferred that the ratio of side chains to backbone units is in the range 1:350 to 1:20, but more preferably 1:100 to 1:30. The side chains are typically statistically distributed along the carbon-carbon polymer backbone since the location of attachment of the side chain on the backbone will depend on the positions of suitable attachment locations in the backbone of the hydrocarbon polymer used in the manufacture.

When the side chains are linked to the polymer backbone via grafted maleic anhydride units, each maleic anhydride unit in the polymer backbone may be derivatised with either zero, one or two side chains.

A preferred polymeric material used in the gum base according to the present invention has side chains, attached directly to carbon atoms in the carbon-carbon polymer backbone, wherein the side chains have the formula

—CH₂CH(CH₃)—C(O)—O—(YO)_{b}—(ZO)_{c}—R⁵

in which Y, Z, R⁵, b and c are as defined above may be prepared by a method which comprises reacting a straight or branched chain hydrocarbon polymer, in a solvent and in an inert atmosphere, with the monomethacrylate compound

CH₂═C(CH₃)C(O)O—(YO)_{b}—(ZO)_{c}—R⁵

in the presence of a free radical initiator. The reaction between the hydrocarbon polymer and the methacrylate compound is carried out as further described in WO2006/016179.

A polymeric material according to the present invention wherein the side chains, attached directly to carbon atoms in the carbon-carbon polymer backbone, have the formula

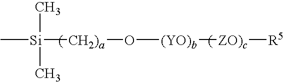

in which Y, Z, R⁵, a, b and c are as defined above, may be prepared by a method which comprises

(i) reacting a compound of the formula

HO—(YO)_{b}—(ZO)_{c}—R⁵

with sodium hydride in a dry organic solvent under inert atmosphere;

(ii) reacting the product from step (I) with the compound

CH₂═CH—(CH₂)_{q}—Br,

where q is 1 or 2,

to give the compound II

CH₂═CH—(CH₂)_{q}—O—(YO)_{b}—(ZO)_{c}—R⁵ II

(iii) reacting the compound II with chlorodimethylsilane to give the compound III

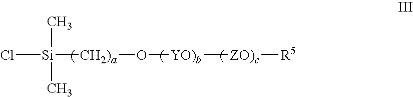

and

(iv) reducing compound III and reacting the product α-hydrodimethylsilyl polyalkylene oxide with a straight or branched chain hydrocarbon polymer containing a multiplicity of carbon-carbon double bonds in the hydrocarbon polymer backbone in the presence of a transition metal salt.

Preferably, in step (ii) above, the product from step (i) is reacted with 3-bromopropene such that, in the formula given above for the side chain, a is 3.

The process is disclosed further in WO2006/016179.

A polymeric material according to the present invention wherein the side chains, attached directly to carbon atoms in the carbon-carbon polymer backbone, have the formula

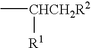

in which one of R¹ and R² is —C(O)Q and the other is —C(O)OR⁴, where Q and R⁴ are as defined above, may be made by a method which comprises reacting polyisoprene-graft-maleic anhydride or a monoester derivative thereof with the compound HO—(YO)_{b}—(ZO)_{c}—R⁵, in which Y, Z, R⁵, b and c are as defined above. Typically, the reaction is carried out in an organic solvent such as toluene.

In the method described above, the number of side chains attached to the polymer backbone will depend on the number of maleic anhydride grafts on the polyisoprene molecule which can take part in the esterification reaction with the alcohol HO—(YO)_{b}—(ZO)_{c}—R⁵. For instance, using a polyisoprene-graft-maleic anhydride of the formula

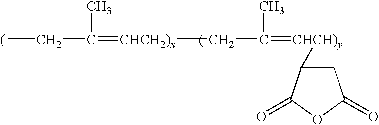

the number of side chains having the general formula given above that can be formed will obviously depend on the value of y. Polyisoprene-graft-maleic anhydride (PIP-g-MA) is available commercially. Purely by way of example one such PIP-g-MA, having the CAS No. 139948-75-7, available from the company, Aldrich, has an average molecular weight of about 25,000. The monomer ratio of isoprene units to maleic anhydride units in this graft copolymer is typically 98:1.1 which indicates that the reaction between this PIP-g-MA and the alcohol described above could produce approximately between 1 and 7 side chains per molecule. Polyisoprene-graft-maleic anhydride may be prepared according to techniques describe in the literature. For instance, according to Visonte L.L. Y. et al, Polymers for Advanced Technologies, Vol 4, 1993, pp 490-495, polyisoprene, dissolved in o-dichlorobenzene, was reacted with maleic anhydride at 180-190° C. to give the modified isoprene. Various polyisoprene-g-maleic anhydride copolymers with 7, 15, 19, 26 and 29 mol % maleic anhydride were obtained by increasing the reaction time from 5 to 11 hours.

The reaction between the PIP-g-MA and the poly(alkyleneoxy) alcohol is typically carried out in an organic solvent such as toluene and typically in the presence of an activator, for example, triethylamine at elevated temperature. The yield of the ester, in this reaction, may be increased by removal of the water from the reaction mixture by azeotropic distillation since toluene and water form azeotropic mixtures which boil at a lower temperature than any of the components. The poly(alkyleneoxy) alcohol may also be reacted with a monoester derivative of PIP-g-MA. For instance, we have achieved good results using a monomethyl ester with the general formula

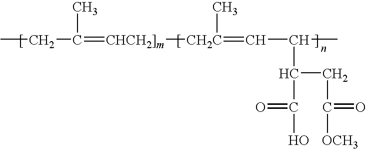

and has a functionality (i.e. n) of approximately 10, an average molecular weight of about 25,000, and a glass transition temperature of −59° C. The reaction of this monomethyl ester with the poly(alkylene oxy) alcohol is typically carried out in an organic solvent such as toluene at an elevated temperature. The yield of ester may be increased by removing water from the reaction mixture by azeotropic distillation. Alternatively the reaction may be performed without solvent, by mixing a melt of either polyisoprene backbone with that of the poly(alkylene oxy) alcohol graft. These methods, although they require the use of preformed polyisoprene having carboxy functionality, have the advantage that they involve relatively simple and quick reactions and give high yields.

When the backbone of the amphiphilic polymeric material is a copolymer of maleic anhydride together with an ethylenically-unsaturated monomer, side chain precursors are typically terminated by an alcohol unit at one end and an alkyloxy group at the other. MeO-PEO-OH is an example of a preferred side chain precursor. In the method of formation of the polymeric material such side chains react with the maleic anhydride derived units via alcoholysis of the anhydride to give a carboxylic ester and carboxylic acid.

The reaction of maleic anhydride with an alcohol is an alcoholysis reaction which results in the formation of an ester and a carboxylic acid. The reaction is also known as esterification. The reaction is relatively fast and requires no catalyst, although acid or base catalysts may be used.

The net reaction may be represented as shown below. Pₓ and P_{y} represent the remainder of the copolymer/terpolymer and ROH is a representative side chain precursor.

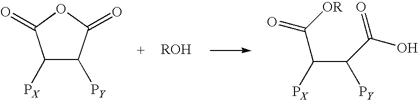

In the method two side chains precursors represented by ROH may react at the same maleic anhydride monomer to give a compound of general formula

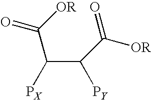

Alternatively, only one side chain precursor reacts per maleic anhydride monomer. This leaves the unit derived from maleic anhydride with a free carboxylic acid group, which may be derivatised at a later stage in the method. This group may also be deprotonated to give an ionic backbone in the polymeric material.

In the method according to this invention the side chain precursors may have hydroxyl groups at each of their termini and each terminus reacts with a unit derived from maleic anhydride in different backbones to form a cross-linked polymeric material.

After reaction of the side chain precursors with the copolymer or terpolymer starting material, any unreacted units derived from maleic anhydride in the backbone may be ring-opened. This may be performed by hydrolysis, or using a base. The resulting product may be ionisable. This further reaction step has particular utility when there is a large proportion of maleic anhydride in the backbone, for instance in an alternating copolymer.

The present invention also provides a chewing gum composition comprising the novel chewing gum base of this invention. The chewing gum composition additionally comprises one or more sweetening or flavouring agents, and preferably comprises both. The chewing gum composition may additionally comprise other agents, including pharmaceutical actives, nutraceutical actives, herbal extracts, stimulants, fragrances, sensates to provide cooling, warming or tingling actions, microencapsulates, abrasives, whitening agents and colouring agents.

The amount of gum base in the final chewing gum composition is typically in the range 5-95% by weight of the final composition, with preferred amounts being in the range 10-50% by weight, more preferably 15-25% by weight.

The sweetening agent may be selected from a wide range of materials including water-soluble artificial sweeteners, water-soluble agents and dipeptide based sweeteners, including mixtures thereof. Preferably, the sweetening agent is sorbitol. The flavouring agents may be selected from synthetic flavouring liquids and/or oils derived from plants, leaves, flowers, fruits (etc.), and combinations thereof. Suitable sweetening and flavouring agents are described further in U.S. Pat. No. 4,518,615.

The chewing gum composition of the present invention may comprise additional polymeric material (i.e. additional to the polymeric material in the chewing gum base), in addition to the chewing gum base, sweetening agent and flavouring agent. Preferably, this additional polymeric material, if present, comprises 1-15%, more preferably 3-15% by weight of the chewing gum composition. It may be soluble or insoluble in water.

A second aspect of this invention provides a method for forming a chewing gum base comprising:

i. 1 to 99% by weight of the chewing gum base of a polymeric material which has a straight or branched chain carbon-carbon backbone and a multiplicity of side chains, and is substantially insoluble in water;

ii. from 0-6% by weight wax;

iii. up to 99% by weight of an elastomeric material different to the polymeric material; and

iv. 0 to 20% by weight of an elastomer plasticiser; and

v. optionally a filler;

where the total amount of polymeric material and elastomeric material is at least 10% by weight of the chewing gum base and wherein the method comprises mixing melted polymeric material, wax (if present), elastomeric material, elastomer plasticiser and filler (if present) to form a gum base mixture.

Preferably the method further includes the step of forming a chewing gum composition by blending the gum base with sweetening and/or flavouring agents. The chewing gum composition may be manufactured by any number of standard techniques known in the art. Methods of production are described further in Formulation and Production of Chewing and Bubble Gum. ISBN: 0-904725-10-3, which includes manufacture of gums with coatings and with liquid centres.

Typically, the gum base is blended with sweetening and flavouring agents in molten form and the blend is cooled to form a chewing gum composition. Alternatively, or as well as, the blend may be compressed to form a chewing gum composition. Cold mixing may also be used to blend the gum base with the sweetening and flavouring agents.

Typically, the gum base comprises 5-95% by weight, preferably 10-50% by weight, more preferably 15-25% of the final chewing gum composition. Additional polymeric material may also be added to form the chewing gum composition, in an amount such that it comprises 1-15%, more preferably 3-15% of the chewing gum composition.

The steps to form the chewing gum composition may be carried out sequentially in the same apparatus, or may be carried out in different locations, in which case there may be intermittent cooling and heating steps.

In this method, the chewing gum base may have any of the preferred features discussed above.

The invention will now be illustrated further in the following Examples, and with reference to the accompanying drawings, in which;

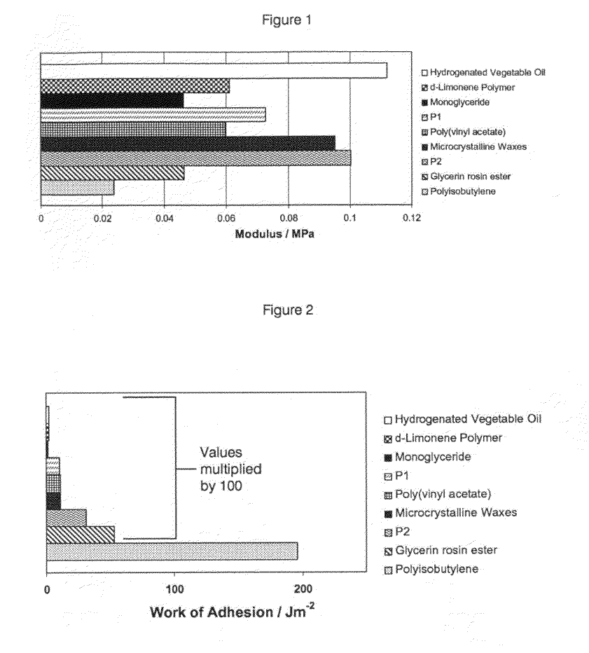

FIG. 1 shows the results of hardness tests for the ingredients in a gum base according to this invention;

FIG. 2 shows the results of adhesion tests for gum base ingredients;

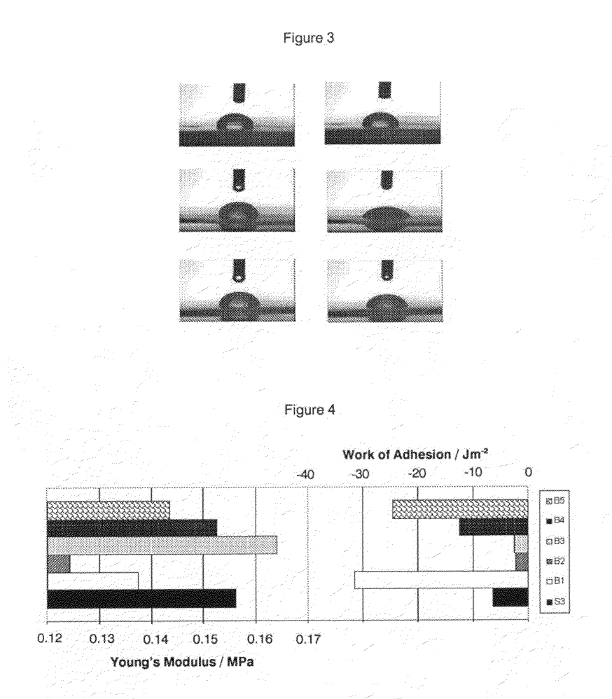

FIG. 3 shows the images of contact angle experiments;

FIG. 4 shows the adhesion and modulus data for the gum base formulations given in Table 8;

FIG. 5 summarises the correlation between hardness and removal times;

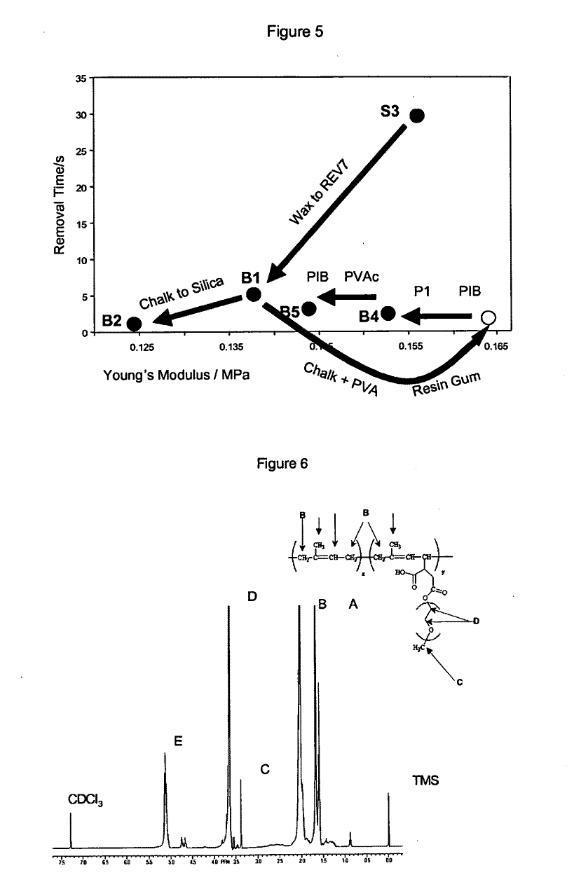

FIG. 6 shows the ¹H NMR spectrum of the product of Example 1.1;

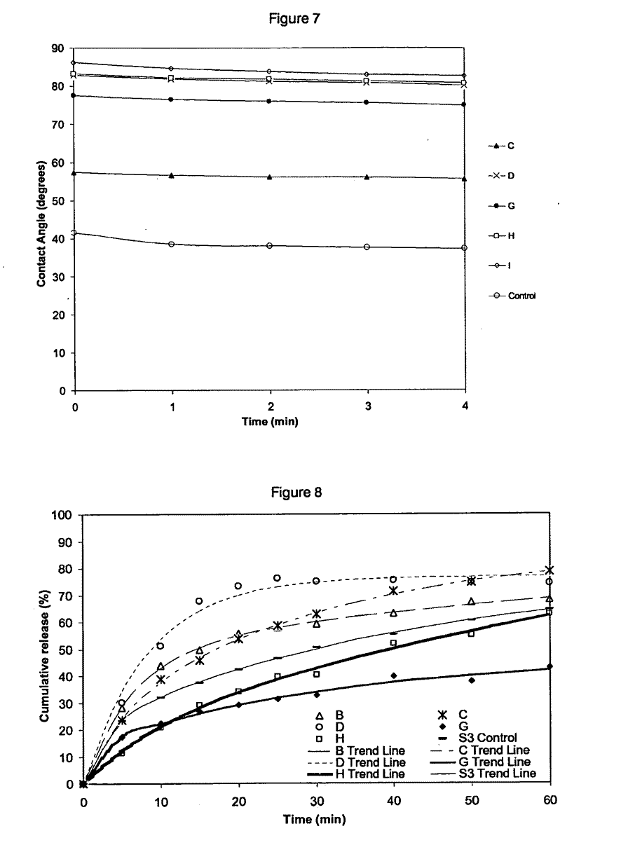

FIG. 7 shows the contact angle measurements for the various graft copolymers;

FIG. 8 shows cinnamaldehyde release from chewing gums; and

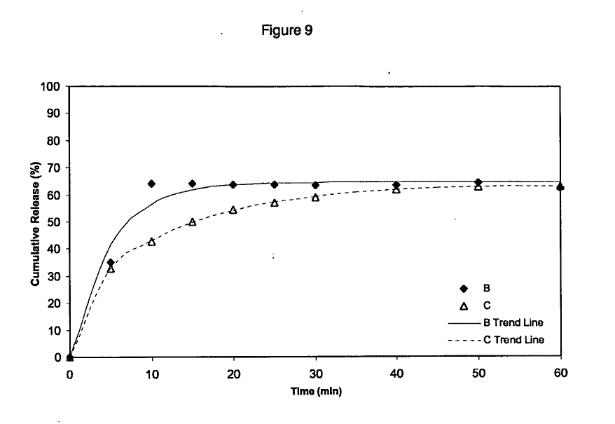

FIG. 9 shows the release of Ibuprofen from samples.

### EXAMPLE 1.1

### Reaction of Polyisoprene-Graft-Maleic Anhydride with poly(ethylene glycol) Methyl Ether (Preparation of P1)

PIP-g-MA (3.50 Kg, Polyisoprene-graft-maleic anhydride obtained from Kuraray, LIR-403 grade) having the CAS No. 139948-75-7, an average M_{w} of approximately 25,000 and a typical level of grafting of MA of around 1.0 mol %, and poly(ethylene glycol) methyl ether (PEGME) (2.67 kg, purchased from Aldrich), having an average molecular weight of 2000 were weighed out and added to an air-tight jacketed reactor with a twenty litre capacity, equipped with an overhead stirrer. Toluene (8.15 Kg) was added to the reactor to dissolve the starting materials, and a flow of nitrogen gas passed through the vessel.

The vessel was then heated to reflux the toluene (115-116° C.) using an oil bath set to 140° C. connected to the reactors jacket. A Dean-Stark trap and condenser between the vessel and nitrogen outlet were used in order to remove any water from the poly(ethylene glycol) methyl ether and toluene by means of azeotropic distillation. Thus water was collected in the Dean-Stark trap over the course of the reaction.

The reaction mixture was refluxed for a total of approximately 37.5 hours. The reaction can also be catalysed by addition of acid or base. The product was purified in 2 L batches by adding the still warm (50° C.) material to 3 L tanks of deionised water. In the case of each batch the water was removed by filtration and the process of washing the graft copolymer with deionised water, and removing the water wash with the aid of filtration repeated a further five times. The product was dried under vacuum at 50° C. for 1 week.

The ¹H NMR spectrum was obtained using a Delta/GX 40 NMR spectrophotometer, operating at 400 MHz, in CDCl₃ (deuterated chloroform). (FIG. 6) P1 was obtained.

### EXAMPLE 1.2

### Reaction of Polyisoprene-Graft-Monoacid Monomethyl Ester with poly(ethylene glycol) Methyl Ether (Preparation of P2)

Poly(ethylene glycol) methyl ether was reacted with PIP-g-MaMme (polyisoprene-graft-monoacid monomethyl ester supplied by Kuraray Co. Ltd., LIR-410 grade). This PIP-g-MaMme has a functionality of 10 (i.e. carboxylic acid groups per molecule), and a molecular weight of approximately 25,000.

Poly(ethylene glycol) methyl ether (PEGME) (2.60 kg, purchased from Aldrich), having an average molecular weight of 2000 was weighed out and added added to an air-tight jacketed reactor with a twenty litre capacity, equipped with an overhead stirrer. The PEGME was melted by heating it to 60° C. and PIP-g-MaMme (3.20 Kg) followed by toluene (7.35 Kg) were added into the reactor, and a flow of nitrogen gas passed through the vessel whilst the materials were mixed.

The vessel was then heated to reflux the toluene (115-116° C.) using an oil bath set to 140° C. connected to the reactor's jacket. A Dean-Stark trap and condenser between the vessel and nitrogen outlet were used in order to remove any water from the polyethylene glycol) methyl ether and toluene by means of azeotropic distillation. Thus water was collected in the Dean-Stark trap over the course of the reaction.

The reaction mixture was refluxed for a total of approximately 98.5 hours. The reaction can also be catalysed by addition of acid or base. The product was purified in 2 L batches typically by adding the still warm (50° C.) material to 3 L tanks of deionised water. In the case of each batch the water was removed by filtration and the process of washing the graft copolymer with deionised water, and removing the water wash with the aid of filtration repeated a further five times. The product was dried under vacuum at 50° C. for 1 week.

The ¹H NMR spectrum was obtained using a Delta/GX 40 NMR spectrophotometer, operating at 400 MHz, in CDCl₃ (deuterated chloroform). P2 was obtained.

The physical properties of the polymers are given in Table 2.

TABLE 2
Polymer Physical Properties: The values in the column headed
Tₘ is the maxima of a transition believed to be associated
with the melting of the PEG chains of the graft copolymers

| Name | Backbone/Side Chain | Mₙ | Tₘ | Quantity |
|---|---|---|---|---|
| P1 | PIP-g-MA/PEO 2K | 30K | 48° C. | 4967 g |
| P2 | PIP-g-MaMme/PEO 2K | 45K | 43° C. | 4896 g |

The solubilities of some of the new graft copolymers and their stating materials are given in Table 3.

TABLE 3

| | | LIR- | PEG- | | |
|---|---|---|---|---|---|
| Solvent | PIP-g-MA | 410 | 2000 | P1 | P2 |
| Water | I | I | S | Swells partly | Swells |
| Methanol | I | I | S | Forms white | Forms clear blue- |
| | | | | suspension | gray solution |
| Chloroform | S | S | S | S | S |
| Toluene | S | S | S | S | S |
| Hexane | S | S | I | Forms white | Swells partly |
| | | | | suspension | |

CODES:
S = soluble,
I = insoluble.

The present results show that the solubility of the starting materials predicts solution properties of the graft polymers. The graft polymers are soluble in chloroform and toluene due to the fact that they are “good” solvents for the backbone and the grafted chains. Methanol is a “selective” solvent for the grafted chains and the polymer appears as a colloidal dispersion. P2 forms a more transparent solution than P1, because P2 has a higher amount of grafted chains. In water (a more polar solvent), the polymers only swell. In a selective solvent for backbone, for example hexane, P2 forms an opaque colloid but the more hydrophilic polymer P1 only swells partially.

### EXAMPLE 1.3

### Polymer Backbones

### 1.3.1 Maleic Anhydride Copolymers

Poly(isobutylene-alt-maleic anhydride):

Two molecular weights (Mₙ: 6000, 60 000 g mol⁻¹, as declared by the supplier), both were obtained from the Sigma-Aldrich company.

Poly(maleic anhydride-alt-1-octadecene):

Molecular weight 30-50 000 g mol⁻¹ (as declared by the supplier) obtained from the Sigma-Aldrich company.

### 1.3.2 Ethylene-Maleic Anhydride Terpolymers

These are random copolymers of ethylene, maleic anhydride, and another monomer.

Poly(ethylene-co-butyl acrylate-co-maleic anhydride)

This is a copolymer of ethylene (91 weight percent), N-butyl acrylate (6%), and maleic anhydride (3%). This material was obtained from Sigma-Aldrich (molecular weight undisclosed and propriety information).

Poly(ethylene-co-vinyl acetate-co-maleic anhydride)

This is a copolymer of ethylene, vinyl acetate and maleic anhydride. The polymer was obtained from Arkema and sold under the Orevac trade name (grade 9304 was used).

### EXAMPLE 1.4

### Graft Copolymers

By “graft copolymer”, we mean “polymeric material”, and these two terms are used interchangeably. A number of graft copolymers where synthesised by grafting MPEG to the backbones described in Table 4.

In all cases the graft was methoxy poly(ethylene glycol) (MPEG), also known as poly(ethylene glycol) methyl ether (PEGME). Material was obtained from two suppliers, the Sigma-Aldrich company, and Clariant (sold as Polyglykol M 2000S). In both cases the polymers were sold as having a molecular weight of 2000, and are believed to have a very similar chemical structure and properties. Polymers A, C-E and G (Table 4) were synthesised using the Aldrich material, the others using the Clariant material.

A number of graft copolymers where synthesised by grafting MPEG to the backbones described above.

TABLE 4
Polymers Examined.

| | | | | | Backbone | MA |
|---|---|---|---|---|---|---|
| Polymer | | Backbone | | Graft | MA Loading | Targeted |
| Sample | Backbone | Mₙ | Graft | Mₙ | (weight %) | (mol %)^{c} |
| A | P(IB-alt-MA) | 6000 | MPEG | 2000 | 64^{a} | 10 |
| B | P(IB-alt-MA) | 6000 | MPEG | 2000 | 64^{a} | 28 |
| C | P(IB-alt-MA) | 60 000 | MPEG | 2000 | 64^{a} | 10 |
| D | P(MA-alt-O) | 30-50 000 | MPEG | 2000 | 28^{a} | 11 |
| E | P(MA-alt-O) | 30-50 000 | MPEG | 2000 | 28^{a} | 11 |
| F | P(MA-alt-O) | 30-50 000 | MPEG | 2000 | 28^{a} | 100 |
| G | P(E-co-BA-co-MA) | Not known | MPEG | 2000 | 3 | 100 |
| H | P(E-co-VA-co-MA) | Not known | MPEG | 2000 | 3^{b} | 50 |
| I | P(E-co-VA-co-MA) | Not known | MPEG | 2000 | 3^{b} | 100 |

^{a}= Polymers are approximately 50 mol % MA, value for weight % depends on Fw of monomer,
^{b}= Backbone loading variable between 1.6-3.2%, values calculated using 3.2%,
^{c}= percentage of available MA targeted for reaction.

As will be apparent from Table 4, often not all of the MA was targeted for reaction. For instance, in the case of Polymer samples A-E only a proportion of the maleic anhydride in the alternating copolymer backbone reacted. This leaves a number of maleic anhydride rings present on the backbones which can themselves be exploited by ring opening (see section on emulsification). It may be noted that in some cases not to all of the maleic anhydride targeted for reaction with MPEG may have been reacted.

### EXAMPLE 1.4.1

### Synthesis of the Graft Copolymer

### Polymer A:

Poly(isobutylene-alt-maleic anhydride) (Mₙ: 6000 g mol⁻¹, 40 g) and poly(ethylene glycol) methyl ether (Mₙ: 2000 g mol⁻¹, 50 g) were dissolved in a mixture of DMF (100 mL) and toluene (100 mL) in a reaction flask. The flask was heated at reflux temperature under nitrogen gas for 24 h, any water present being removed from the reaction by means of azeotropic distillation and collection into a Dean-Stark apparatus. The resulting polymer solution was cooled and precipitated into diethyl ether, the polymer recovered using filtration, and dried to remove traces of solvent. The grafting of MPEG onto the backbone was confirmed using infra-red spectroscopy using a Bruker spectrometer by observing changes in the region 1700-1850 cm⁻¹ associated with the maleic anhydride units.

### Polymer B:

Polymer B was synthesized in the same manner as Polymer A using poly(ethylene glycol) methyl ether (Mₙ: 2000 g mol⁻¹, 110 g) as the graft. Reaction was allowed to continue for a total of 36 h. The polymer was characterised in a similar manner to polymer A.

### Polymer C:

Polymer C was synthesized in the same manner as Polymer A using Poly(isobutylene-alt-maleic anhydride) (Mₙ: 60 000 g mol⁻¹, 40 g) as the backbone. The polymer was characterised in a similar manner to polymer A.

### Polymer D:

Polymer D was synthesized in the same manner as Polymer A using poly(maleic anhydride-alt-1-octadecene) (Mₙ: 30-50 000 g mol⁻¹, 50 g) as the backbone and poly(ethylene glycol) methyl ether (Mₙ: 2000 g mol⁻¹, 30 g) as the graft. Toluene (200 mL) was used as the reaction solvent; in this case the polymer solution was precipitated in water. The amphiphilic nature of the resulting graft copolymer led to a poor yield (25% of the theoretical). The polymer was characterised in a similar manner to polymer A.

### Polymer E:

Polymer E was synthesised in the same manner as Polymer D except that the polymer solution was not precipitated in water, instead the reaction solvent was removed under vacuum. This material was consequently isolated in a higher yield than P4, and may be suitable for applications where excess PEG in the final product is not a critical issue. The polymer was characterised in a similar manner to polymer A.

### Polymer F:

Polymer F was synthesised in the same manner as Polymer D using poly(maleic anhydride-alt-1-octadecene) (Mₙ: 30-50 000 g mol⁻¹, 20 g) poly(ethylene glycol) methyl ether (Mₙ: 2000 g mol⁻¹, 136 g) as the graft. Toluene (500 mL) was used as the reaction solvent; the polymer solution was precipitated in hexane. Reaction was allowed to continue for a total of 36 h. The polymer was characterised in a similar manner to polymer A. Excess PEG may be removed from the polymer via dialysis or a similar methodology.

### Polymer G:

Polymer G was synthesized in the same manner as Polymer. A using poly(ethylene-co-butyl acrylate-co-maleic anhydride) (40 g) as the backbone and poly(ethylene glycol) methyl ether (Mₙ: 2000 g mol⁻¹, 30 g) as the graft. A mixture of xylene (100 mL) and toluene (100 mL) was used as the reaction solvent; in this case the polymer solution was precipitated in ethanol. The polymer was characterised in a similar manner to polymer A.

### Polymer H:

Polymer G was synthesized in the same manner as Polymer A using poly(ethylene-co-vinyl acetate-co-maleic anhydride) (40 g) as the backbone and poly(ethylene glycol) methyl ether (Mₙ: 2000 g mol⁻¹, 13 g) as the graft. A mixture of xylene (125 mL) and toluene (125 mL) was used as the reaction solvent; in this case the polymer solution was precipitated in ethanol. The polymer was characterised in a similar manner to polymer A.

### Polymer I:

Polymer I was synthesized in the same manner as Polymer H using poly(ethylene glycol) methyl ether (Mₙ: 2000 g mol⁻¹, 39 g) as the graft. The polymer was washed thoroughly with more ethanol after filtration to remove PEG from the polymer. The polymer was characterised in a similar manner to polymer A.

### EXAMPLE 2.1

### Standard Gum Base Samples: Large Scale [500 g]

The components for the three standard gum bases are given in Table 5 below. The standard gum base formulations were prepared using a Winkworth 2L 2Z Horizontal Z-blademixer using the following protocol:

The temperature was set to 125° C.

The rear gear speed ratio was set to: 5:1.

The gum base ingredients in Table 5 were added sequentially to the mixer.

A mixing time of 90 minutes was allowed.

TABLE 5
Standard Gum base Ingredients

| Materials | S1 (%) | S2 (%) | S3 (%) |
|---|---|---|---|
| Polyisobutylene (PIB) | 12.5 | 12 | 13 |
| Poly(vinyl acetate) (PVAc) | 12.5 | 16 | 15 |
| Calcium Carbonate | 12.5 | 35 | 30 |
| Glycerol Ester Resin (GER) | 12.5 | 11.5 | 18 |
| Microcrystalline Wax (WAX) | 12.5 | 6 | 6 |
| Hydrogenated Veg. Oils | 12.5 | 8 | 12 |
| Monoglyceride | 12.5 | 5 | 6 |
| d-limonene Polymer | 12.5 | 6.5 | 0 |

### EXAMPLE 2.2

### Standard Gum Base Samples: Medium Scale [25 g]

The components for the three standard gum bases are given in Table 5. The standard gum base formulations were prepared using a Haake Polydrive Mixer Torque Rheometer using the following protocol:

The temperature was set to 110° C.

The torque was set to 80 N cm.

Mixing time 70 minutes.

The gum base ingredients in Table 5 were added sequentially to the rheometer

### EXAMPLE 2.3

### Standard Gum Base Samples: Lab Scale [5 g]

The laboratory gum base samples where made using a Haake MiniLab extruder/mixer using the following protocol:

The temperature was set to 100° C.

The torque was set to 80 N cm.

The gum base ingredients in Table 5 were added sequentially to the mixer

A mixing time of 60 minutes was allowed.

### EXAMPLE 3

### Experimental Procedures

### EXAMPLE 3.1

### Chewing Tests

For the chewing tests 1 g of the gum bases samples were masticated for 5 minutes and assessed for cohesion, chewability and mouth feel.

TABLE 6

| | Sample | | | |
|---|---|---|---|---|
| | (Is sample | Component | Polymer | |
| Compound | chewable?) | Removed | Added % | Comments |
| S1 | Yes | None | None | Generally good |
| S1 − PIB + P2 | No | PIB | P2, 12.5 | Breaks up |
| S1 − GER + P2 | No | GER | P2, 12.5 | Breaks up |
| S2 | Yes | None | None | Generally good |
| S3 | Yes | None | None | Stickier than S2 |
| S2 + P1 | Yes | None | P1, 5.0 | Good texture (better than S2) |
| S3 + P1 | Yes | None | P1, 5.0 | Same as S2 + R7 but softer |
| S2 − WAX + P1 | Yes | WAX | P1, 6.0 | Harder than all above |
| S3 − WAX + P1 | Yes | WAX | P1, 6.0 | Same as above but softer |

(see Table 5 for definitions)

The “−” and “+” signs indicate that all of the component following the “−” is replaced by the component following the “+”.

The samples so far indicate that substituting P2 for the ingredients gives less tacky and harder dry gum bases but gives poorer chewing characteristics. The P1 substitution gives good results for all properties.

### EXAMPLE 3.2

### Removal Test: Dynamic

0.5 g gum samples were weighed out and chewed for 5 minutes before being split in two, with each piece was rolled into a ball, rinsed under running water for 5 minutes before being placed onto the rough non-glazed side of a small tile (N.B. no manual compression before cover tile placement). A piece of PTFE tape was placed on top of samples to stop adhesion to the glazed cover tile.

Samples were heated at 25° C. in a thermostatted environmental chamber. A large cover tile was placed, with the smooth glazed side down, on top of the samples. Care was taken to ensure the samples were not near the corners of the cover tile. A 1 L Duran bottle filled with water was placed on the center of the covering tile. Samples were removed from heater box after 24 hours, covered with a piece of paper towel and left to stand at room temperature overnight before being tested.

The samples for this test were prepared by rolling the chewed cuds into balls. The samples were then compressed under the cover slide for 48 hours. This method of preparation should give reproducible sized and shaped samples. The flow of water was provided by a peristaltic pump and a reservoir of water was maintained by connection to a water supply. The jet of water had a flow rate of 500 mLs/min. The nozzle aperture was ˜1 mm and the distance of the pipette tip from the sample was 2 cm and the angle of attack was ˜45°. The water jet was focused on the leading edge of the chewing gum sample where it meets the tile. The time was noted when the samples began to peel and again when then were removed. The dynamic test data are summarised in Table 7. Addition of P1 to S2 and to S3 has a marked effect reducing the removal time by 60% and 80% respectively. Larger differences are found when the wax is replaced with P1 which dropped the removal time by a factor of 10 for S2. For S3 the drop was not so large, but this sample was softer and hence spreads more easily. The small edge up time however, is significant.

TABLE 7
Dynamic Removal Tests

| Code | Result 1 | Result 2 |
|---|---|---|
| S2 | >30 min | >30 min |
| S2 + P1 | 10 min 20 sec | 13 min 20 sec |
| S2 − WAX + P1 | 3 min 20 sec | 3 min 6 sec |
| S3 | >30 min | >30 min |
| S3 + P1 | 6 min | 8 min 37 sec |
| S3 − WAX + P1 | Edge up 5 min | Edge up 6 min 30 sec |
| | off 7 min 24 sec | off 13 min 12 sec |

>30 min: sample still stuck to tile after 30 minutes

### EXAMPLE 3.3

### Hardness and Adhesion Tests Using the TA-XT Texture Analyser

A TA-XT texture analyser was used in this Example. For the adhesion/hardness tests the ingredients were cast into films from solvent (chloroform). The gum bases were melted to give samples of 2 g with an approximate thickness of 6 mm. There are two basis protocols used:

1. Force mode: a probe of diameter 6 mm is brought into contact (at a speed of 0.5 mm/s) with the sample until a force of 500 g is achieved by the probe. The probe then holds this force for 10 seconds and then retracts at the same speed until a zero force has been reached. The cycle can then be repeated. The advantage of this method relies on the ability to subject all the samples to the same load.

2. Penetration mode: a probe of diameter 6 mm is brought into contact. (at a speed of 0.5 mm/s) with a 2 g, 6 mm thick sample until a 2 mm penetration is achieved. The probe then retracts at the same speed until a zero force has been reached.

From these data the adhesive force (the maximum adhesive load), the modulus (stress/strain) and the work of adhesion (integration of, the force x per distance per unit area of surface) can be obtained. The modulus measurements are given in units of g/s. The experiment is repeated several times as the first approach may be inaccurate because the samples may not be completely flat. Data can be taken from the 2^{nd} approach or averaged for multiple runs. All experiments in this phase were carried out at room temperature and ambient humidity.

FIG. 1 show the results of the hardness test for all the ingredients of the gum bases. The hardness is a modulus and is the response of the materials to stress. The data shows quite clearly that at room temperature the only soft material is the poly(isobutylene).

FIG. 2 shows an adhesion test on the raw materials after compression at a fixed stress. The data follow the hardness tests showing that the only appreciable adhesion comes from the poly(isobutylene) elastomer. As a result, the values of the work of adhesion of the other components are multiplied by a factor of 100 in FIG. 2 to make the bars on the chart clearer to the viewer. This is not unexpected behaviour at room temperature for the pure polymer.

TABLE 8
Substituting P1 for WAX

| Sample | Modulus g/s | Adhesion Jm⁻² |
|---|---|---|
| S2 | 4670 ± 500 | 1.5 ± 1.2 |
| S2 − WAX + P1 | 3058 ± 700 | 31 ± 10 |
| S3 | 4292 ± 700 | 3.6 ± 1.8 |
| S3 − WAX + P1 | 3282 ± 100 | 6.0 ± 3.0 |

Experiments on replacing the wax in formulations S2 and S3 showed changes in both hardness and adhesion and this data is given in Table 8. In this case the gum base becomes softer and slightly tackier. In these experiments the wax component has been substituted with the new polymers. The first aim here was to incorporate the new polymers into gum bases and this has been successful with no evidence of phase separation. The second factor is to investigate whether the samples become softer on mixing with water, the pure samples swell when immersed and this is discussed in the next section.

### EXAMPLE 3.4

### Water Contact Angle Tests for Gum Bases

Contact angles for water droplets on films made from gum bases were carried out as follows:
0.25 g of the sample was weighed out.
The sample was then melted onto a flat surface at 100° C.
A droplet of water was placed on the sample surface.
The contact angle of the droplet on the sample surface was measured at t=0 min.
The contact angle of the droplet on the sample surface was measured at t=10 min.

The water absorption is shown in the contact angle experiments illustrated in FIG. 3 where the base gum can be seen to readily absorb moisture; the contact angle decreases. This was as expected and all the samples made with the new polymers.

Table 5 shows the results from chew tests on some of the samples discussed above. Clearly the chewability though subjective is a crucial element.

FIG. 3 shows the results of this Example. The left hand column is the immediate contact angle and the right hand column after 10 minutes. The top sample is the standard base gum (S3), the middle sample with PVAc replaced by P1 and the bottom sample with PVAc replaced by P2.

### EXAMPLE 4

The formulations used in this Example are described in Table 9. S3 is a generic formula based on literature precedents and as such is used as a reference in all subsequent tests. The gum bases denoted B1 to B5 contain new polymeric materials. The sample denoted B2 has silica as a filler which is a medium size fraction; other fractions are also available.

TABLE 9
Standard Gum Base Ingredients

| Materials | S3 | B1 | B2 | B3 | B4 | B5 |
|---|---|---|---|---|---|---|
| Polyisobutylene | 13 | 13 | 13 | 13 | 10 | 12 |
| Poly(vinyl acetate) | 15 | 15 | 15 | 20 | 20 | 18 |
| Calcium carbonate | 30 | 30 | 0 | 36 | 36 | 36 |
| Silica-1 | 0 | 0 | 30 | 0 | 0 | 0 |
| Glycerol ester resin | 18 | 18 | 18 | 7 | 7 | 7 |
| Picolite resin | 0 | 0 | 0 | 0 | 0 | 0 |
| Hydrogenated | 12 | 12 | 12 | 12 | 12 | 12 |
| vegetable oils | | | | | | |
| Microcrystalline wax | 6 | 0 | 0 | 0 | 0 | 0 |
| Monoglyceride | 6 | 6 | 6 | 6 | 6 | 6 |
| P1 | 0 | 6 | 6 | 6 | 9 | 9 |

### Experimental Procedures

### EXAMPLE 4.1

### Chewing Tests

For the chewing tests 1 g of each gum base was masticated for 5 minutes, to assess cohesion, chewability and mouth feel; several different individuals contributed.

### Results and Discussion

### Adhesion and Hardness Results

FIG. 4 summarises adhesion and modulus data for the series of gum base formulations given in Table 9, using a TA-XT texture analyser. These measurements were carried out with dried samples, and as expected there is some correlation between hardness and adhesiveness. Table 10 summarises the numerical values. S3 (the reference gum base) is one of the hardest samples and has a midway low adhesiveness.

Replacement of wax by the P1 polymer has two effects: the sample becomes softer and the apparent adhesiveness increases substantially. This is expected as P1 is a softer material than the wax it replaces. However, this becomes unimportant in the removal tests with water (see below). Replacement of the calcium carbonate filler with micron sized silicas modifies the hardness and reduces adhesion as measured in the dry test. The affinity of the PEO for silica is higher than for chalk and although the hardness values do not vary dramatically for most of the samples tested, the adhesion does. These data are useful in describing the dry bulk properties of the formulations but they do not give a clear prediction of the removability.

### Removal Experiments

The removal experiments were carried out in the dynamic mode as described. The results are summarised in Table 10 and in the correlation graph in FIG. 5. Replacing the wax in S3 by P1, B1, has a significant effect, the gum base is softer but is easily removed because of the amphiphilic character imparted by the grafted PEO. A further improvement [B3] can be made in the gum base by substantially reducing the Resin Gum [GER] and making up this balance by adding extra filler [calcium carbonate] and poly(vinyl acetate). This sample is both harder and easier to remove. An alternative strategy is to replace the filler [CAC] with silica. The effect is to reduce the hardness slightly compared to B1 but it also reduces the removal times (sample B2). Further modifications have been carried out by varying the elastomer [PIB] and P1 concentrations as in sample B4. Here this is a slight softening and slight increase in removal time but the effects overall are quite small. Sample B5, where the balance of PIB and PVAc were optimised, showed a further reduction in hardness but only a small change in removal time.

TABLE 10
Summary of test results on gum bases

| | Young's | Adhesion | | Average | | Contact |
|---|---|---|---|---|---|---|
| | Modulus | Energy | | Removal | Contact | Angle |
| Gum Base | (Mpa) | (J/m²) | Chewability | Time (min) | Angle t = 0 | t = 10 min |
| S3 | 0.200 | 6.6 | 1 | >30 | 130.6 | 128.8 |
| B1 | 0.134 | 31.4 | 1 | 5 | 112.2 | 105.2 |
| B2 | 0.180 | 6.8 | 1 | 4 | | |
| B3 | 0.164 | 2 | 1 | <2 | 101.4 | 96.2 |
| B4 | 0.153 | 11.8 | 1 | 4 | | |
| B5 | 0.143 | 24.5 | 1 | 3 | | |

### Water Absorption

The water contact angle data is given in Table 10 where a clear decrease (improved wettability) is seen for all the samples containing P1. The data for B2 shows a further reduction.

### EXAMPLE 5

### Chewing-Gums

A preliminary set of formulations were made to test the incorporation of sugars and flavourings into the new gum bases. Table 11 gives details. The samples were prepared using the Haake MiniLab micro compounder. A small quantity of P1 was also included to help the components mix homogeneously with the gum bases; being amphiphilic P1 acts as an emulsifier and can also reduce sugar, crystallisation. Table 11 gives some details on the finished products. All the gum bases and chewing gums made have acceptable oral characteristics.

TABLE 11
Chewing Gum Formulations

| Material | Weight (%) |
|---|---|
| Sweeteners | 53.5 |
| Glycerine | 1.5 |
| Flavourings | 1 |
| P1 | 6 |
| Gum Base | 38 |

TABLE 12
Chewing Gum Properties

| Gum Base | S3 | B1 |
|---|---|---|
| Texture | Homogeneous | Homogeneous |
| Chew | Good | Very Good |
| Flavour | Strong | Medium |

### EXAMPLE 6

### Adhesion Tests

### 6.1 Aim

To measure the ability of films of graft copolymers A-I to reduce the ability of an adhesive substance (commercial chewing gum) to stick to a substrate, thus creating a non-stick surface. This should provide information as to which polymers reduce the adhesiveness of gum formulations.

### 6.2 Methodology

### Preparation of Discs

A series of smooth discs of 5 cm diameter and 3 mm thickness were created by cutting rods of nylon, PTFE, brass, and stainless steel to the appropriate size. Solutions of the polymers under test were then prepared. Polymer A was dissolved in THF (5 weight % solution); C was dissolved in THF (3.3 weight % solution); F in THF (2.5 weight % solution); polymers B, G, H and I were dissolved in toluene (5 weight % solutions), and D dissolved in ethyl acetate (2.5 weight % solution). The still warm solutions were then carefully applied to the discs with the aid of a small brush, one of each substrate being coated with each solution. The discs were left for at least 30 minutes to dry, prior to being recoated. The total number of coats was adjusted according to the concentration of the solutions, so that for instance a total of four coats were applied in the case of 5 weight percent solutions, eight in the case of 2.5 weight percent solutions. The discs were left overnight in the fume cupboard to fully dry.

### Test Conditions

Pieces of chewing gum (Wrigley's Extra brand, peppermint flavour) were chewed for 5 min, and a freshly chewed piece applied to each dry disc. A square piece of PTFE film was then placed on top of the gum, and a weight comprised of a 1 L glass bottle filled with 1 L of water was placed on top of the PTFE square.

The samples were left for three nights after which the weights were removed and the PTFE squares (with gum cuds attached) were then carefully peeled back using the human hand to gauge the force with which the cuds were stuck to the surface of the discs. PTFE was used since it creates a thin, inert layer, which is easy to remove.

### 6.3 Results

Nine polymers were tested on the four substrates, the stickiness of the gum to the discs was assessed on a scale between 1-5, one representing a test with very low adhesion between gum cud and substrate surface, five representing a surface with very high adhesion between the two (Table 13). Control experiments in which no polymer coating was present were also carried out, in order to determine the effect of the coating in reducing adhesion compared with the unprotected substrate.

TABLE 13
Results of the Adhesion Tests of Chewing
Gum to films of the Polymers.

| Polymer | Nylon | PTFE | Brass | Stainless Steel |
|---|---|---|---|---|
| A | 1 | 3 | 2 | 1 |
| B | 1 | 3 | 1 | 1 |
| C | 1 | 5 | 1 | 1 |
| D | 1 | 1 | 2 | 1 |
| F | 1 | 1 | 3 | 1 |
| G | 3 | 5 | 2 | 1 |
| H | 1 | 2 | 1 | 1 |
| I | 1 | 1 | 1 | 3 |
| Control | 3 | 5 | 4 | 5 |

It is clear from the control that generally high adhesion is observed between the four substrates and the gum cuds. The graft copolymers are all suitable for reducing the adhesiveness of the surfaces. In all cases, with the sole exception of polymer F, the graft copolymers created a non-stick surface on nylon; with the exception of polymers E and F they created a non-stick surface or surface with reduced stickiness on the PTFE discs. All of the graft copolymers created a non-stick or surface with reduced stickiness on both of the metal surfaces.

### 6.4 Conclusion

The graft copolymers are suitable for reducing the adhesion of surfaces. Universally they reduced the adhesiveness of metal surfaces, and in almost all cases reduced adhesiveness of gum to polymer substrates.

### EXAMPLE 7

### Contact Angle Measurements

### 7.1 Aim

To measure the ability of the graft copolymers to mediate the properties of the surface by using the varying hydrophilicity of the materials to make surfaces either water repellent or to encourage wetting of the surface. Without being bound by theory, good wetting of the surface may increase the removability of gum formulations.

### 7.2 Methodology

Smooth glass discs of 5 cm diameter and 3 mm thickness were prepared by cutting glass rods to the appropriate size. These were coated using solutions prepared in a similar manner to in Example 6.2. The concentrations of all the solutions were 2.5 weight percent, polymers A-C, and F were dissolved in THF; D was dissolved in ethyl acetate, and G-1 dissolved in toluene.

In all cases the still warm solutions were carefully applied to the glass discs with the aid of a small brush. The discs were left for at least 30 minutes to dry, prior to being recoated. The total number of coats was adjusted according to the concentration of the solutions, so that for instance a total of four coats were applied in the case of 5 weight percent solutions, eight in the case of 2.5 weight percent solutions. The discs were left overnight in the fume cupboard to fully dry.

Following this a drop of water was placed on each disc and the contact angle between the water and substrate measured using a Kruss prop Shape Analysis contact angle goniometer (Model no. DSA 10-Mk2).

### 7.3 Results

The contact angle of a droplet of water was measured on films of the polymers and an uncoated glass control every 30 s for 10 min. In some cases, the water droplet's contact angle decreased so rapidly that it was not possible to measure its value over the full period of ten minutes. In these cases, an attempt was made to measure the initial contact angles.

TABLE 14
Initial and Final Contact Angles for the Various Graft Copolymers

Contact Angle

| Polymer | t = 0 min | t = 4 min |
|---|---|---|
| C | 57.4 | 55.5 |
| D | 82.8 | 80.2 |
| G | 77.6 | 75 |
| H | 83.3 | 80.7 |
| I | 86.1 | 82.6 |
| Control | 41.6 | 34.6 |

The contact angle data is probably most easily compared and visualised in FIG. 7.

Water was observed to make a contact angle with the glass of approximately 42° after 0 min, and 35° after 4 min. FIG. 7 depicts the contact angle of water with discs coated with a number of different polymers. Whilst some wetting of the surfaces occurs on the discs, it will be seen that the graft copolymers increase the contact angle of water with the discs indicating that they provide some degree of water repellency to the surface. Polymers G, H and I offer the highest degrees of water repellency, probably due to their high hydrophobicity as the materials have a fairly low loading of PEG. In general, materials with a lower hydrophobicity had a lower contact angle. Whilst samples C and D had a similar loading of PEG, those in D had long chain alkyl octadecene groups which will affect the overall hydrophilic/lipohiphilic balance (HLB) of the graft copolymers, and thus explaining the lower contact angle observed on films of C. Thus whether the amphiphilic copolymers are more hydrophilic or hydrophobic and the subsequent behaviour of the graft copolymers can be altered by changing the backbone and the loading of PEG to that required. A contact angle of 0° was recorded after 2 min on a disc coated with F (not show in FIG. 7). This is (without being bound to theory) presumably because the water soluble polymer had been dissolved at this stage, or had absorbed the water. It is of note that the backbone of D and F is identical, differing only in the loading of PEG (that in F being five times higher). This suggests that the hydrophilicity of the graft copolymers can be adjusted to render them as either wetting or water repellent agents.

### 7.4 Conclusions

The tunable amphiphilic nature of the graft copolymers means the interaction of water with surfaces coated with them, can be altered by changing the backbone and degree of amphiphile grafted to the backbone.

### EXAMPLE 8

### Use of the Amphiphilic Graft Copolymers A-I to Mediate the Release of a Chemical Entity from Chewing Gum

### 8.1 Aims

To demonstrate that the use of the graft copolymers in chewing gum in mediating the release of a chemical entity (in this case the commercial flavour cinnamaldehyde).

### 8.2 Methodology

### Chemicals

Calcium carbonate (CaCO₃), ester gum, hydrogenated vegetable oil (HVO, hydrogenated soy oil), polyisobutylene (PIB, of molecular weight 51,000), poly(vinyl acetate) (PVAc, of molecular weight 26,000), glyceromonostearate (GMS), microcrystalline wax (microwax of m.p. 82-90° C.), sorbitol liquid, and sorbitol solid, were all food grade materials obtained from the Gum Base Company. Cinnamaldehyde (98+%) was obtained from Fisher-Scientific UK.

### Manufacture of Chewing Gum

The chewing gum base had the composition as shown in the table below:

TABLE 15
Recipe for the Manufacture of the Gum Bases X is one of the
new graft copolymers, or microcrystalline wax in the case of the
S3 control, HVO = hydrogenated vegetable oil,
PVAc = poly(vinyl acetate).

| Stage | Component | % Composition | Mass/g |
|---|---|---|---|
| 1 | PIB | 13 | 1.04 |
| | PVAc | 6 | 0.48 |
| | CaCO₃ | 6 | 0.48 |
| | Ester Gum | 3.6 | 0.288 |
| 2 | Ester Gum | 5.4 | 0.432 |
| | CaCO₃ | 9 | 0.72 |
| 3 | PVAc | 9 | 0.72 |
| | Ester Gum | 9 | 0.72 |
| | CaCO₃ | 15 | 1.2 |
| 4 | HVO | 12 | 0.96 |
| | GMS | 6 | 0.48 |
| | X | 6 | 0.48 |
| | Total | 100 | 8 |

The gum base materials were mixed on a Haake Minilab micro compounder manufactured by the Thermo Electron Corporation, which is a small scale laboratory mixer/extruder. The ingredients were mixed together in four steps, the gum only being extruded after the final step. The gum base was mixed at 100° C.

The chewing gum was mixed according to the following table.

TABLE 16
Ingredients for the Chewing Gum X is one of the new
graft copolymers, or microcrystalline wax in the case
of the S3 control.

| Stage | Time | Component | Amount | |
|---|---|---|---|---|
| 1 | 15 min | 37.5% Gum Base Containing X | 3 | g |
| | | 10% Sorbitol Liquid | 0.8 | g |
| | | 17% Sorbitol Powder | 1.36 | g |
| 2 | 15 min | 25.5% Sorbitol Powder | 2.04 | g |
| | | 6% X | 0.48 | g |
| | | 3% Sorbitol Liquid | 0.24 | g |
| | | 1% Cinnamaldehyde Flavour | 0.08 | mL |
| | 30 min | TOTAL | 8 | g |

The gum was mixed using the same equipment as the base and extruded after the final step. The gum was mixed at 60° C. In stage 1 the sorbitol liquid and powder were premixed prior to adding them to the gum.

### Experimental Method

Each pre-shaped piece of gum was weighed before chewing, and the weight recorded to allow estimation of the total quantity of drug in each piece.

A ‘ERWEKA DRT-1’ chewing apparatus from AB FIA was used, which operates by alternately compressing and twisting the gum in between two mesh grids. A water jacket, with the water temperature set to 37° C. was used to regulate the temperature in the mastication cell to that expected when chewed in vivo, and the chew rate was set to 40 ‘chews’ per minute. The jaw gap was set to 1.6 mm.

40 mL artificial saliva (composed of an aqueous solution of various salts, at approx pH 6—see below, Table 17) was added to the mastication cell, then a plastic mesh placed at its bottom. A piece of gum of known weight was placed on the centre of the mesh, and a second piece of mesh put on top.

TABLE 17
Artificial Saliva Formulation

| Components | Quantity (mmol/L) |
|---|---|
| KH₂PO₄ | 2.5 |
| Na₂HPO₄ | 2.4 |
| KHCO₃ | 15 |
| NaCl | 10 |
| MgCl₂ | 1.5 |
| CaCl₂ | 1.5 |
| Citric acid | 0.15 |

PH adjusted to 6.7 with HCl

Procedure for Analysing the Release Profiles of Active Ingredients from Gum

The parameters in Table 18 were always used in chewing unless otherwise noted.

TABLE 18
Chewing Parameters

| Parameter | Value |
|---|---|
| Temperature | 37° C. |
| Gaps between jaws | 1.6 mm |
| Twisting angle | 20° |
| Chew Frequency | 40 strokes/min |

At the start of each run, the cell containing the artificial saliva and gum was left for 5 minutes so that the system could equilibrate to 37° C. The gum was then masticated. A sample volume of 0.5 mL was then withdrawn from the test cell periodically during a release run (5, 10, 15, 20, 25, 30, 40, 50 and 60 minutes).

All the samples were then analysed by HPLC using a typical Perkin Elmer HPLC Series 200 system, equipped with an autosampler, pump, and diode array detector. Data handling and instrument control was provided via Totalchrom v 6.2 software.

The gums (approximately 1 g pieces of known weight) were placed between two plastic meshes and chewed mechanically in artificial saliva. They were all analysed using HPLC apparatus. Details of this equipment are as follows:

A typical Perkin Elmer HPLC system—data handling and instrument control via Totalchrom v 6.2. System based on a Series 200 system, equipped with an autosampler, pump, and diode array detector.

In this case the HPLC analysed free cinnamaldehyde in solution that had been released by chewing. The set of conditions for cinnamaldehyde are as follows:

### Column: Varian Polaris 5u C18-A 250×4.6 m

Mobile Phase Acetonitrile/0.05% orthophosphoric acid (60/40)
Flow: 1 mL/min

### Detection: UV 25 0 nm

### Inj vol: 5 μL

Samples in saliva were injected neat after filtration through a 10 mm PTFE acrodisc syringe filter.

The samples were compared against standards (prepared in artificial saliva) covering the range 0.02-1.00 mg/mL. The retention time of cinnamaldehyde was determined to be 4.9 min on this equipment, thus the peak at this retention time was used to detect the released cinnamaldehyde. The samples were chewed two or three times, and in all cases two consistent release curves were generated. All of the samples were run in duplicate on the HPLC apparatus, indicating the results were highly reproducible.

### 8.3 Results

Gums have been made with polymers A-D and F-I, and chewed in artificial saliva, the released cinnamaldehyde is analyzed by HPLC. A control (S3) in which the graft copolymers were replaced with microwax was also made, and analyzed in the same manner (FIG. 8).

The control (S3) is observed to give a fairly steady release of cinnamaldehyde culminating in approximately 60% release after 60 min. Whilst two (H and I) graft copolymer containing gums have release profiles similar to the microwax material, most have either faster and higher maximum, or slower and lower maximum release profiles of the cinnamaldehyde. For instance, polymer H only releases 40% of the cinnamaldehyde in the gum after 60 min; compared with 50% in the case of the control. By contrast, cinnamaldehyde release from the gum made using D appears to have reached a plateau of approximately 70% cinnamaldehyde release before 30 min. The release rate from the gum containing C was slower, but the maximum release was comparable or slightly higher.

### 8.4 Conclusions

By altering the backbone and the degree of grafting (therefore hydrophilicity) of the amphiphile it is possible to alter the release profile of chemical species from chewing gum, in this case demonstrated with cinnamaldehyde. The release rate is seems to be determined by a number of factors including chemical identity of the backbone, and degree of grafting, resulting in changes in the interactions with saliva and other components of the gum. Therefore graft copolymer systems with a range of different release rates potentially available for formulation into chewing gum are disclosed.

### EXAMPLE 9

### Use of the Amphiphilic Graft Copolymers to Mediate the Release of an Active Ingredient

### 9.1 Aims

To demonstrate the use of the amphipihilic graft copolymers to deliver and release active ingredients, demonstrated by looking at the release of ibuprofen from solid mixtures of the polymers and ibuprofen, i.e. where the ibuprofen has been encapsulated. By encapsulated, we mean that the active ingredient is physically coated by, or encased, within the graft copolymer. Such an encapsulated material could be dispersed in chewing gum to make it more palatable to the consumer.

### 9.2 Methodology

### Materials

Ibuprofen (40 grade) was obtained from Albemarle.

### Creation of Solid Mixes of Polymer and Ibuprofen

The powdered graft copolymer and ibuprofen were weighed out into a beaker to ensure that the ibuprofen comprised 1 weight percent. The two were premixed with a spatula to create a roughly homogenous mixture, and then mixed and extruded using the Haake Minilab micro compounder at 60° C. In the case of Polymer B 3.96 g of polymer and ibuprofen (0.04 g) were used; in the case of Polymer C 2.97 g of polymer and ibuprofen (0.03 g) were used.

### Testing Method

The encapsulated ibuprofen samples (approximately 1 g material of known weight) were placed between two plastic meshes and chewed mechanically in artificial saliva. Details of the mastication of the encapsulated ibuprofen is identical to that used with the cinnamaldehyde chewing gum (8.2), samples being taken after 5 min, 10 min, 15 min, 20 min, 25 min, 30 min, 40 min, 50 min, and 60 min. Following this they were prepared for HPLC analysis by filtering them through a 10 mm PTFE acrodisc syringe filter. The samples were analyzed using the HPLC apparatus described previously (8.2), using the following experimental details:

Ibuprofen HPLC details: (Column: Hypersil C18 BDS, 150×4.6 mm; Mobile phase: Acetonitrile/0.05% aqueous orthophosphoric acid in a 60/40 ratio, 1 mL/min; UV detector, wavelength—220 nm).

The encapsulated ibuprofen samples were chewed two or three times, and in all cases two consistent release curves were generated. All of the samples were run in duplicate on the HPLC apparatus, indicating the results were highly reproducible.

### 9.3 Results

Two different polymers were used to encapsulate the ibuprofen, both were chewed and the release profile monitored by HPLC (FIG. 9).

Both of the polymer/ibuprofen mixtures released ibuprofen into solution during chewing, and released similar total amounts of ibuprofen into the saliva—around 60% of the maximum total, a point at which the release seems to plateau in the two examples tested. Interestingly the release of ibuprofen is much more rapid in the case of polymer B than polymer C, whereas both polymers have chemically similar backbones, the amount of MPEG grafted to the backbone is much higher in the case of B. A possible explanation therefore is that increasing the hydrophilicity of the polymers aids disintegration of the encapsulated samples, resulting in faster release during chewing/grinding (the polymers are hard solids).

### 9.4 Conclusions

Ibuprofen was encapsulated in two samples of the graft copolymers, and released by masticating the samples in artificial saliva. Graft copolymer B releases ibuprofen more rapidly than graft copolymer C, the former also contains more PEG and is more hydrophilic. It seems that by adjusting the hydrophilicity of the amphiphilic graft copolymers it is possible to alter the release rate of the ibuprofen.

1. A chewing gum base comprising
i. 1 to 99% by weight of a polymeric material which has a straight or branched chain carbon-carbon backbone and a multiplicity of side chains, and is substantially insoluble in water;
ii. from 0-6% by weight wax;
iii. up to 99% by weight of an elastomeric material different to the polymeric material; and
iv. 0 to 20% by weight of an elastometer;
in which the total amount of polymeric material and elastomeric material is at least 10% by weight of the chewing gum base.

2. A chewing gum base according to claim 1, wherein the polymeric material comprises 2-90% by weight of the chewing gum base.

3. A chewing gum base according to claim 1, comprising substantially no wax.

4. A chewing gum base according to claim 1, wherein the elastomeric material is synthetic or natural rubber.

5. A chewing gum base according to claim 4, wherein the elastomeric material is selected from butadiene-styrene copolymers, polyisobutylene and isobutylene-isoprene copolymers.

6. A chewing gum base according to claim 1, in which the ratio of elastomeric material plus polymeric material to elastomer plasticiser is at least 5:1.

7. A chewing gum base according to claim 1, comprising substantially no elastomer plasticiser.

8. A chewing gum base according to claim 1, wherein the elastomer plasticiser comprises methyl, glyceryl or pentaerythrityl esters of rosins or modified rosins, or terpene resins, or mixtures thereof.

9. A chewing gum base according to claim 1, additionally comprising a non-toxic vinyl polymer, a filler, a softener and/or an emulsifier.

10. A chewing gum base according to claim 1, wherein the backbone of the polymeric material is derived from a homopolymer of an ethylenically unsaturated hydrocarbon monomer or from a copolymer of two or more ethylenically-unsaturated polymerisable hydrocarbon monomers.

11. A chewing gum base according to claim 10, wherein the carbon-carbon polymer backbone is derived from a homopolymer of an ethylenically-unsaturated polymerisable hydrocarbon monomer containing 4 or 5 carbon atoms.

12. A chewing gum base according to claim 11, wherein the carbon-carbon polymer backbone is derived from a homopolymer of isobutylene.

13. A chewing gum base according to claim 11, wherein the carbon-carbon polymer backbone is derived from a homopolymer of butadiene or isoprene.

14. A chewing gum base according to claim 10, wherein the carbon-carbon polymer backbone is derived from a copolymer of isobutylene and isoprene.

15. A chewing gum base according to claim 10, wherein the carbon-carbon polymer backbone is derived from a butadiene-styrene block copolymer.

16. A chewing gum base according to claim 1, wherein the side chains of the polymeric material are derived from poly(ethylene oxide), poly(propylene oxide), polyglycine, poly(vinyl alcohol), poly(styrene sulphonate) or poly(acrylic acid).

17. A chewing gum base according to claim 16, wherein the side chains are derived from poly(ethylene oxide) and the backbone is derived from a homopolymer of isoprene.

18. A chewing gum base according to claim 1, wherein the side chains are derived from a siloxane, a (poly)silane, a polyalkylsilane, an alkylsilyl polyoxyalkylene or a fluoroalkane.

19. A chewing gum base according to claim 1, comprising two or more polymeric materials.

20. A chewing gum base according to claim 1, wherein the side chains of the polymeric material have the formula 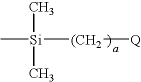
or have the formula 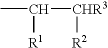
wherein R¹ is H, —C(O)OR⁴ or —C(O)Q and R² is —C(O)OR⁴ or —C(O)Q
provided that at least one of R¹ and R² is the group —C(O)Q;
R³ is H or —CH₃;
R⁴ is H or an alkyl group having from 1 to 6 carbon atoms;
Q is a group having the formula —O—(YO)_{b}—(ZO)_{c}—R⁵, wherein each of Y and Z is, independently, an alkylene group having from 2 to 4 carbon atoms and R⁵ is H or an alkyl group having from 1 to 4 carbon atoms;
a is 3 or 4, and each of b and c is, independently, 0 or an integer of from 1 to 125 provided that the sum b+c has a value in the range of from 10 to 250.

21. A chewing gum base according to claim 20, wherein the side chains in the polymeric material have the formula 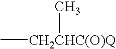
wherein Q is as defined in claim 20.

22. A chewing gum base according to claim 20, wherein the side chains in the polymeric material have the formula 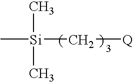
wherein Q is as defined in claim 20.

23. A chewing gum base according to claim 20, wherein the side chains in the polymeric material have the formula 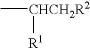
wherein one of R¹ and R² is —C(O)Q and the other is —C(O)OR⁴, in which Q and R⁴ are as defined in claim 20.

24. A chewing gum base according to claim 20, wherein in Q the alkylene groups Y and Z are both —CH₂CH₂—.

25. A chewing gum base according to claim 20, wherein in Q the group R⁵ is H.

26. A chewing gum base according to claim 20, wherein in Q the group R⁵ is —CH³.

27. A chewing gum base according to claim 20, wherein in Q the sum b+c has a value in the range of from 40 to 50.

28. A chewing gum base according to claim 1, wherein the filler is silica.

29. A chewing gum composition comprising a chewing gum base according to claim 1, and one or more sweetening or flavouring agents.

30. A chewing gum composition according to claim 29, comprising additional polymeric material, in addition to the chewing gum base, sweetening agent and flavouring agent.

31. A chewing gum composition according to claim 30, wherein the additional polymeric material comprises 3-15% by weight of the chewing gum composition.

32. A chewing gum composition according to claim 29, comprising 10-50% by weight chewing gum base.

33. A method for forming a chewing gum base, in which a base is formed comprising:
i. 1 to 99% by weight of the chewing gum base of a polymeric material which has a straight or branched chain carbon-carbon backbone and a multiplicity of side chains, and is substantially insoluble in water;
ii. from 0-6% by weight wax;
iii. up to 99% by weight an elastomeric material excluding the polymeric material; and
iv. up to 20% by weight of an elastomer plasticiser; and
v. optionally a filler;
wherein the total of the amount of polymeric material and elastomeric material is at least 10% by weight of the chewing gum base and wherein the method comprises mixing melted polymeric material, wax (if present), elastomeric material, elastomer plasticiser and filler (if present) to form a gum base.

34. A method according to claim 33, comprising a subsequent step in which the gum base is blended with one or more sweetening or flavouring agents to form a chewing gum composition.

35. A method according to claim 34, wherein the gum base is blended with one or more sweetening or flavouring agents in molten form to form a blend and the blend is cooled to form a chewing gum composition.

36. A method according to claim 34, wherein the gum base is blended with sweetening and flavouring agents and compressed to form a chewing gum composition.

37. A method according to claim 34, wherein the chewing gum base comprises 10-50% by weight of the chewing gum composition.

38. A method for forming a chewing gum base, in which a base is formed comprising:
i. 1 to 99% by weight of the chewing gum base of a polymeric material which has a straight or branched chain carbon-carbon backbone and a multiplicity of side chains, and is substantially insoluble in water;
ii. from 0-6% by weight wax;
iii. up to 99% by weight an elastomeric material excluding the polymeric material; and
iv. up to 20% by weight of an elastomer plasticiser; and
v. optionally a filler;
wherein the total of the amount of polymeric material and elastomeric material is at least 10% by weight of the chewing gum base and wherein the method comprises mixing melted polymeric material, wax (if present), elastomeric material, elastomer plasticiser and filler (if present) to form a gum base, wherein the chewing gum base has the features of claim 2.
